(19) United States
(12) Patent Application Publication
(10) Pub. No.: US 2020/0209806 A1
(43) Pub. Date: Jul. 2, 2020

(54) Active Light-Field Holographic Elements, Light-Field Display Devices, and Methods

(71) Applicant: 3D Patents LLC, Mission Hills, KS (US)

(72) Inventors: Thomas L. Burnett, III, Austin, TX (US); Kendall Heath James, Austin, TX (US); Nicholas Flynn Jameson, Cedar Park, TX (US); Ronald Craig Larcom, Cedar Park, TX (US)

(73) Assignee: 3D Patents LLC, Mission Hills, KS (US)

(21) Appl. No.: 16/686,164

(22) Filed: Nov. 17, 2019

Related U.S. Application Data
(60) Provisional application No. 62/768,873, filed on Nov. 17, 2018.

(51) Int. Cl. G03H 1/00; G03H 1/22; G02B 30/26

(52) U.S. Cl. CPC G03H 1/0005; G03H 1/2205; G03H 2223/19; G03H 2001/0088; G03H 2222/12; G02B 30/26

(57) ABSTRACT

An apparatus includes a plurality of integrated active holographic elements (Hogels). Each hogel includes one or more light-emitting elements, a micro-lens array, and circuitry to drive the one or more light-emitting elements. The circuitry may be implemented as a quad flat no leads (QFN) package. In some implementations, a plurality of integrated active hogels may be coupled together to form a tile, which includes tile circuitry to drive the integrated circuits of each of the hogels. Multiple tiles may be coupled to one another to form a panel, which includes panel circuitry to drive each of the tiles. Multiple panels may be coupled to one another to form a display device, which may include a display circuit coupled to the panel circuitry of each of the panels.

### CROSS-REFERENCE TO RELATED APPLICATION(S)

The present disclosure is a non-provisional of and claims priority to U.S. Provisional Patent Application No. 62/768,873 filed on Nov. 17, 2018 and entitled “Active Hogel”, which is incorporated herein by reference in its entirety.

### CROSS-REFERENCE TO RELATED APPLICATION(S)

This invention was made with government support under Government Contract Number FA8650-19-P-6009 awarded by the United States Air Force. The government has certain rights in the invention.

### FIELD

The present disclosure is generally related to active light-field (integral ray) holographic elements (Hogels), and more particularly to active hogels, display devices comprised of active hogels, and methods of providing a light-field display for real-time light-field holographic visualizations. The present disclosure describes embodiments that may include a full-parallax solid-state digital field-of-view display comprised of a plurality of hogels.

### BACKGROUND

Conventionally three-dimensional models and scenes are rendered/projected onto two-dimensional planes or screens. Visualizations of complex three-dimensional data in two-dimensions can hinder a viewer's ability to correctly visualize the space or object or to rapidly make critical and effective decisions.

### SUMMARY

Embodiments of integrated light-field holographic elements (hogels) and displays formed from a plurality of such hogels are described below, which may provide a full-parallax, perspective-correct, three-dimensional image. In some implementations, the three-dimensional image may be created by the superposition of a dense bundle of rays projected from each of hogels, where the dense bundle of rays represents the directional distribution of color and intensity of light, recreating or representing the manner in which light is reflected from an object's surface.

In some embodiments, a device comprises a plurality of hogels. Each hogel comprises drive circuitry, light-emitters, and a micro-lens to angularly distribute light. In some implementations, the plurality of hogels may be coupled to one another and positioned to provide a light-field display of a selected size.

In other embodiments, an apparatus may include a display circuit and a plurality of hogels coupled to the display circuit. Each display element of the plurality of hogels may include drive circuitry, one or more light-emitting elements, and a micro-lens array to angularly distribute light from the one or more light-emitting elements to provide an array of light beams of different orientations and different intensities.

In other embodiments, an apparatus may include a panel formed from a plurality of interlocking tiles, where each tile is comprised of a plurality of hogels. Each hogel may include an integrated circuit including optical driver circuitry, one or more light-emitting elements coupled to the optical driver circuitry, and a micro-lens array.

### BRIEF DESCRIPTION OF THE DRAWINGS

The detailed description is set forth with reference to the accompanying figures. In the figures, the left most digit(s) of a reference number identifies the figure in which the reference number first appears. The use of the same reference numbers in different figures indicates similar or identical items or features.

FIG. 1 depicts a light-field holographic display system implemented as a table with one or more touchscreen control interfaces, in accordance with certain embodiments of the present disclosure.

FIG. 2 depicts a light-field holographic display system implemented as a floor display, in accordance with certain embodiments of the present disclosure.

FIG. 3 depicts a light-field holographic display system implemented as a wall display, in accordance with certain embodiments of the present disclosure.

FIG. 4 depicts a portion of a device including a plurality of integrated active hogels, in accordance with certain embodiments of the present disclosure.

FIG. 5 depicts a diagram of a portion of an array of integrated active holographic display elements depicting light rays and dimensional relationships, in accordance with certain embodiments of the present disclosure.

FIG. 6 depicts an implementation of an integrated active hogel, in accordance with certain embodiments of the present disclosure.

FIG. 7 depicts a block diagram of a portion of a system including an implementation of an integrated active hogel, in accordance with certain embodiments of the present disclosure.

FIG. 8 depicts a block diagram of an implementation of an integrated active hogel, in accordance with certain embodiments of the present disclosure.

FIG. 9 depicts a tile formed from a plurality of integrated active hogels, in accordance with certain embodiments of the present disclosure.

FIG. 10 depicts a portion of a display system including a plurality of integrated active hogels, in accordance with certain embodiments of the present disclosure.

FIG. 11 depicts a diagram of a processing pipeline of a tile formed form a plurality of active hogels, in accordance with certain embodiments of the present disclosure.

FIG. 12 depicts a panel comprising a plurality of tiles, each of which is comprised of a plurality of active hogels, in accordance with certain embodiments of the present disclosure.

FIG. 13 depicts a tile formed from a plurality of active hogels and including alignment pins, in accordance with certain embodiments of the present disclosure.

FIG. 14 depicts a tile including tile alignment pins to enable alignment of the tile relative to adjacent tiles to form a panel, in accordance with certain embodiments of the present disclosure.

FIG. 15 depicts a diagram of a portion of circuitry of a panel comprising multiple tiles of active hogels, in accordance with certain embodiments of the present disclosure.

FIG. 16 depicts a block diagram of a bus architecture of an embodiment of a display system including one or more panels comprised of a plurality of tiles comprised of a plurality of sets of active hogels, in accordance with certain embodiments of the present disclosure.

FIG. 17 depicts a block diagram of a computing device that may be used in conjunction with a device comprised of panels and tiles formed from a plurality of integrated active hogels 412, in accordance with certain embodiments of the present disclosure.

FIG. 18 depicts a flow diagram of a method of providing a display comprised of a plurality of active hogels, in accordance with certain embodiments of the present disclosure.

While implementations are described in this disclosure by way of example, those skilled in the art will recognize that the implementations are not limited to the examples or figures described. It should be understood that the figures and detailed description thereto are not intended to limit implementations to the form disclosed, but on the contrary, the intention is to cover all modifications, equivalents, and alternatives falling within the spirit and scope as defined by the appended claims. The headings used in this disclosure are for organizational purposes only and are not meant to limit the scope of the description or the claims. As used throughout this application, the word “may” is used in a permissive sense (in other words, the term “may” is intended to mean “having the potential to”) instead of in a mandatory sense (as in “must”). Similarly, the terms “include”, “including”, and “includes” mean “including, but not limited to”.

### DETAILED DESCRIPTION OF ILLUSTRATIVE EMBODIMENTS

In some embodiments, systems and methods for producing a three-dimensional holographic image from a plurality of integrated active holographic display elements is described. A holographic display, as used here, includes an array of hogels (as opposed to an array of pixels for a standard, 2D display) arranged on a 2D surface. The hogel array may or may not be a regular array. For example, the hogel array may be denser in the middle than the edges of the hogel display. The hogel display is configured to modulate light not only as a function of location but also as a function of direction (or angle) as the light emerges from each hogel.

In some implementations, the hogel is a physical component including circuitry, light-emitting elements, and a micro-lens, which focuses the light into a plurality of rays, each of which represents a point—a specific spatial element of hogel data—on the 2D surface. The hogel controls the color and intensity of each light ray that emerges from the micro-lens.

Each hogel emits a group or bundle of light rays or beams, which are emitted in different directions. In contrast, a pixel is typically a point on a surface having an intensity and a color that are controlled independent of direction. By controlling the color and intensity of light emerging in different directions from multiple hogels, three-dimensional (3D) images may be generated that do not require viewing devices to be visible. The autostereoscopic 3D image can be experienced without additional equipment, such as special eyewear, and without the user's eyes having to be in a predetermined position. In some instances, images having less than full parallax may also be generated, such as images having horizontal or vertical parallax, for example.

The 2D hogel surface may be of any shape (such as flat, concave, convex, spherical, etc.). In some implementations, the shape of the hogel surface may be determined to provide a selected field of view. Though hogel spatial locations may be specified using two coordinates—when the hogel surface is known, for example—in some embodiments, the spatial location of the hogels may be specified using three coordinates. Other implementations are also possible.

In some implementations, the color and intensity may refer to values of the three primary colors red, green, and blue (which may be used to represent different hues of color). Other color spaces are also possible.

In some implementations, a holographic light-field display (sometimes referred to as an “integral ray display”) may be configured to receive and convert 3D data to hogel data, which may then be used by the hogel display to produce a 3D image. Hogel data may include a four-dimensional (4D) array of color and intensity values—two coordinates designating spatial location and two coordinates designating angular direction from each location as described above. The 3D data that is converted may be presented in variety of different formats, such as a virtual reality modeling language (VRML) and from different applications (such as Sketchup, GlobalManager, ProEngineer, and so on). The 3D data may be generated, for example, by scans of real-world scenery or objects or the 3D data may be generated by a computing device.

In some embodiments, the light-field display may include a 2D light modulator in combination with optics for converting the spatially modulated pixels to directionally modulated hogel beams. Each hogel may be represented by a sub-array of pixels, such as an array of 10×10 pixels, an array of 100×200 pixels, or an array of another size. Directional modulation of the light may be accomplished by mapping each pixel within each sub-array to a different output direction, light ray, or hogel beam. The mapping may be accomplished, for example, with different types of optics, such as refractive optics, diffractive optics, reflective optics, metamaterials, volume holographic optics, nano-optics, other optics, or any combination thereof.

Embodiments of systems, methods, and devices are described below that enable holographic displays of information, which can assist operators to visualize available information three-dimensionally. The systems, methods, and devices may provide a field of light display without the need for headgear or other assistive vision technology.

Embodiments of the systems, methods, and devices of the present disclosure may provide a light-field display that correctly projects a full parallax, perspective-correct, 3D image by superposition of a dense bundle of rays that represent the directional distribution of color and intensity of light. The light-field display may present a light-field holographic image that is perspective correct for all viewers within the view volume.

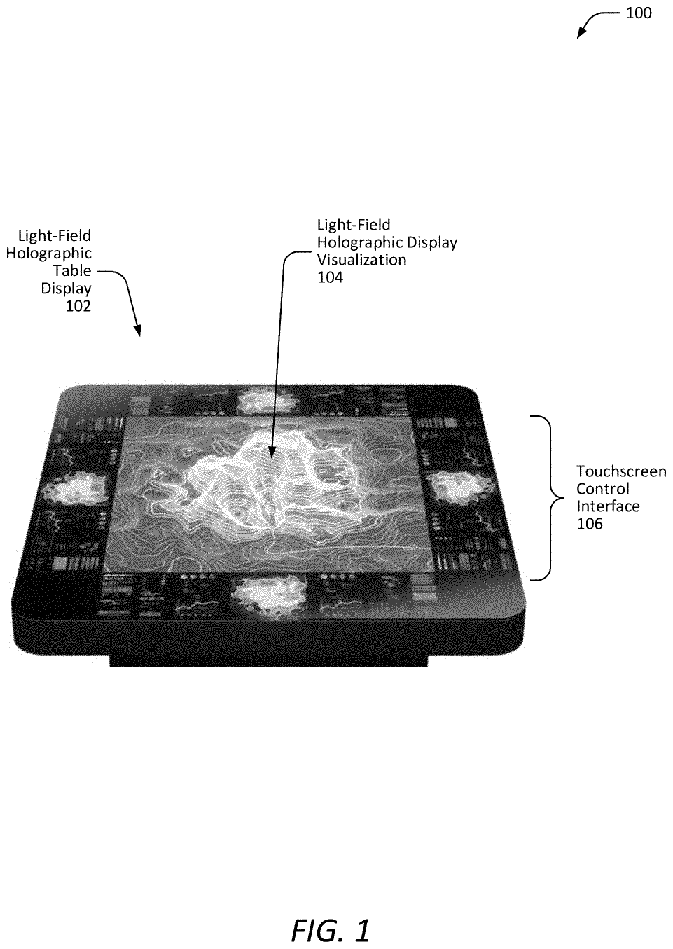

In some implementations, the light-field display architecture may include a plurality of active hogels including a quad-flat no leads (QFN) package to couple each active hogel to drive circuitry of the system. Utilizing a QFN package allows the active hogels to be positioned closer to one another on a circuit package than if a different type of connection were used. As a result, seams between adjacent hogels are reduced to provide a seamless light-field image. An example of a display system comprised of a plurality of active hogels is described below with respect to FIG. 1.

FIG. 1 depicts a light-field holographic display system 100 implemented as a table with one or more touchscreen control interfaces, in accordance with certain embodiments of the present disclosure. The system 100 includes a light-field table display 102 configured to provide a field of light display providing a holographic image or holographic display visualization 104. In this example, the table display 102 may include one or more touchscreen control interfaces 106. For example, the one or more touchscreen control interfaces 106 may include touch-sensitive interfaces through which one or more operators may interact with the table display 102. In one example, the operator may enlarge a portion of the light-field visualization 104. In another example, the operator may alter the data presented by the table display 102, such as by selecting a portion of the display data for expansion or by selecting different display data. Other implementations are also possible.

In the illustrated example of FIG. 1, the table display 102 is displaying a light-field display visualization 104 including a topographical map. For example, the system 100 may automatically generate the light-field display visualization 104 from image data, laser range-finding data, data from another data source, or any combination thereof.

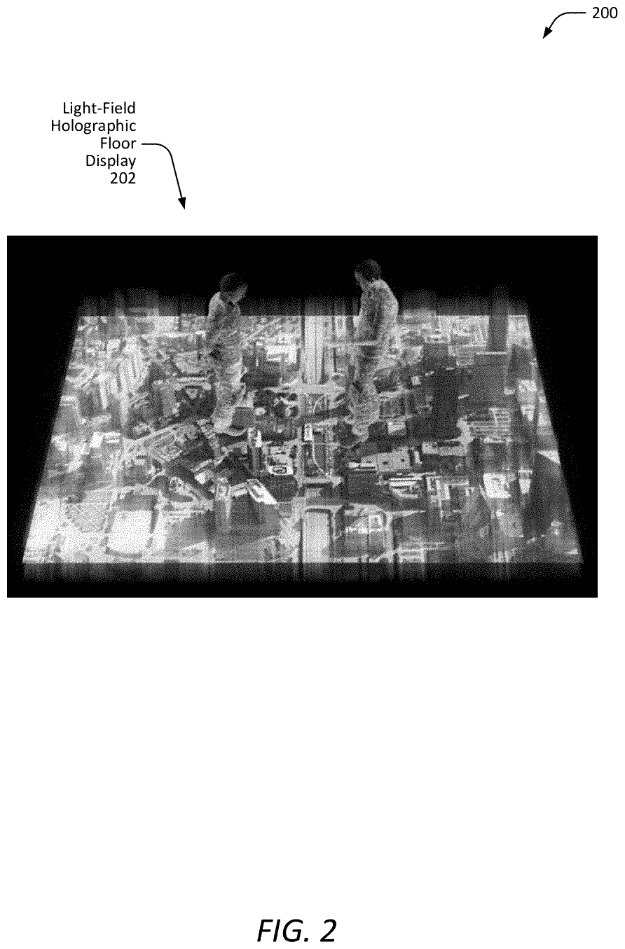

FIG. 2 depicts a light-field holographic display system 200 implemented as a light-field floor display 202, in accordance with certain embodiments of the present disclosure. The light-field floor display 202 may be implemented beneath the floor, which may have a glass or plexiglass cover configured to allow emitted light to pass through.

In the illustrated example, the light-field floor display 202 is showing a city-scape on which one or more operators may move about. In this example, an operator could review a portion of the city to determine one or more changes or adjustments. The changes or adjustments may be entered by the operator using a tablet computer, a smartphone, or another computing device. In some implementations, the system 200 may be configured to detect movements or gestures, and to adjust the light-field display visualization based on the detected movements or gestures. Other implementations are also possible.

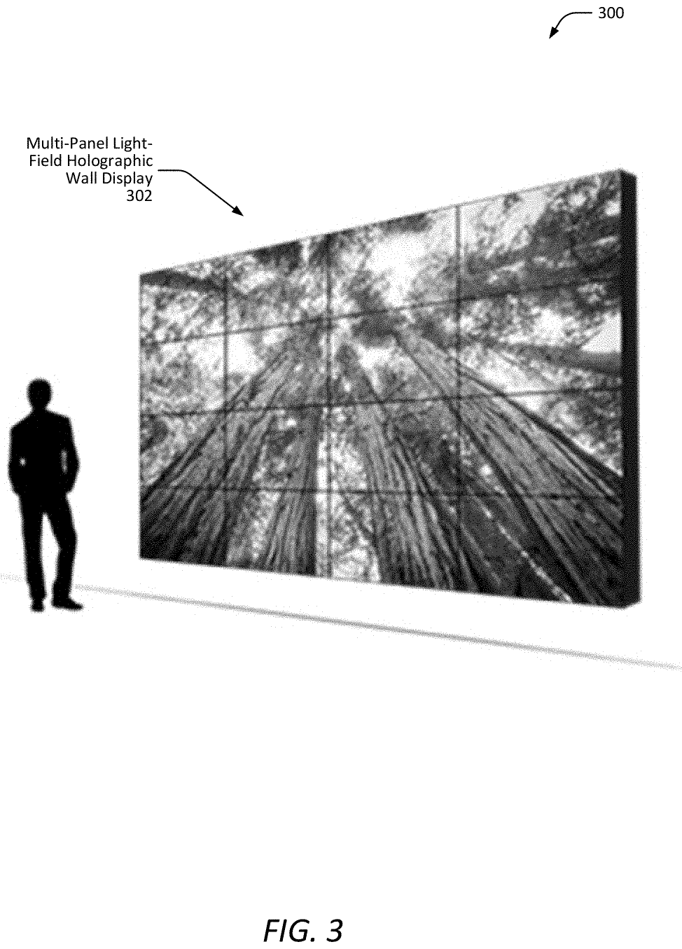

FIG. 3 depicts a light-field holographic display system 300 implemented as a light-field wall display, in accordance with certain embodiments of the present disclosure. In this example, the system 300 includes a multi-panel light-field wall display 302, where each panel is formed from a plurality of panels comprised of integrated active hogels. The panels are arranged edge to edge to form the display 302. In some implementations, borders of adjacent panels may be formed such that the panels interconnect without presenting a visual discontinuity. Other implementations are also possible.

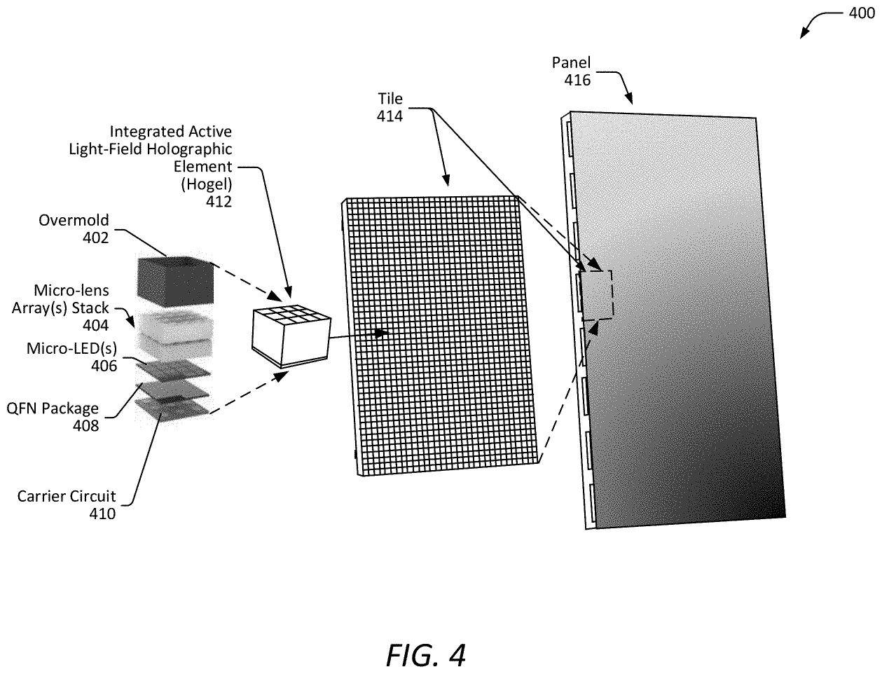

FIG. 4 depicts a portion of a device 400 including a plurality of integrated active hogels, in accordance with certain embodiments of the present disclosure. The device 400 includes an integrated active hogel 412 including a carrier circuit 410 coupled to a quad flat no leads (QFN) package 408, which is coupled to a plurality of micro-light-emitting diodes (micro-LEDs) 406. The integrated active hogel 412 may further include one or more micro-lens array stacks 404 and a sleeve or overmold 402 extending around the micro-LEDs 406 and the micro-lens array stack 404. In some implementations, the overmold 402 may secure and align components of the integrated active hogel 412. Further, in some implementations, the overmold 402 may limit stray light that might otherwise cause interference between adjacent hogels 412.

In this implementation, the micro-LEDs 406 may operate as spatial light modulators (SLMs), which may be manufactured as small as a single hogel 402 or expanded, depending on manufacturing limits. The one or more micro-lens array stacks 404 may reduce the production cost and may reduce non-refundable engineering costs significantly.

Multiple integrated active hogels 412 may be coupled to produce a tile 414. Multiple tiles 414 may be coupled to produce a panel 416. In some implementations, a display may include one or more panels 416. By utilizing the modular configurations, the display may be scaled as needed for a selected implementation.

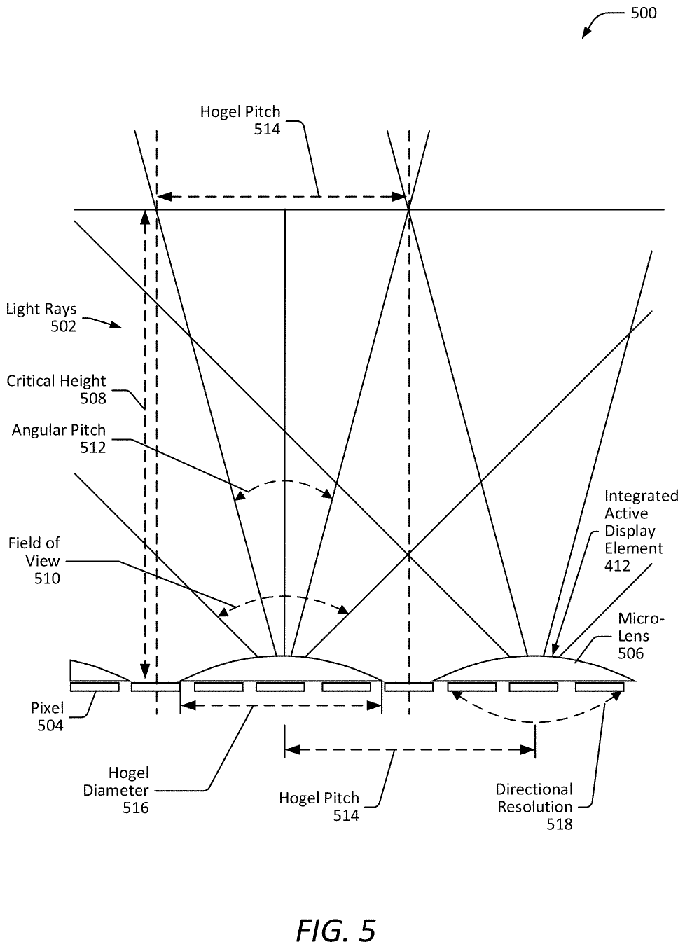

FIG. 5 depicts a diagram 500 of a portion of an array of integrated active hogels 412 depicting light rays 502 and dimensional relationships, in accordance with certain embodiments of the present disclosure. The integrated active hogels 412 may include a micro-lens 506 to direct light associated with one or more pixels 504 to form the light rays 502.

In this example, the micro-lens 506 directs the light rays 502 to provide a field of view 510 that is approximately 60 degrees. The field of view 510 of a light field display may be largely determined by the use case. In one example, a large, collaborative light-field display may have a field of view 510 of approximately 90 degrees, allowing multiple users to see all content on the display. In another example, a small, personal-use light-field display may have a field of view 510 as low as a 30-35 degrees, allowing an individual user to use the display such that the user is in the correct zone to view the display.

The diagram 500 also shows the angular pitch 512, the hogel pitch 514, the hogel diameter 516, and the directional resolution 518. The relationship between these items are described below.

Additionally, the field of view 510 is partially related to a tradeoff between space and angle, because the pixels 504 under each micro-lens are divided across the field of view 510 of the micro-lens 506. This tradeoff is a consideration in the optical design of the system. In a light-field display, pixels are projected through an array of micro-lenses 506 array to create the three-dimensional projected image. The size of each micro-lens 506 may be a factor in the spatial-angular relationship of the display. As the size of the micro-lens 506 is increased, the lens-to-lens spacing increases, which decreases the spatial resolution of the display. As the number of pixels under each micro-lens 506 increases, the angular resolution of the display (of a given field of view) increases as each micro-lens 506 may project more unique angular rays. The pixel count along one axis of the micro-lens 506 is known as the directional resolution (Dr) 518.

In contrast, as the size of the micro-lens 506 is decreased, lens-to-lens spacing decreases, which increases the spatial resolution of the display. However, as the size of the micro-lens 506 is decreased, the number of pixels under each micro-lens 506 decreases, which decreases the angular resolution of the display as each micro-lens 506 can project fewer unique angular light rays 502.

As a design consideration, the spatial-angular tradeoff may be used to determine whether the number of pixels should be used to increase the spatial resolution or the angular resolution of the display. The spatial and angular resolutions have contradictory design goals; therefore, a compromise may be selected during the design process.

The illustrated example of FIG. 5 represents a simplified example in which only three pixels are presented under each micro-lens 506 with approximately a 60-degree field of view 510. The micro-lens 506 includes only three pixels 504.

The angular resolution Ar may be determined according to the following equation:

$$Ar = \frac{Dr}{FoV} \qquad ( Equation 1 )$$

where the variable Dr represents a directional resolution 518 that is the number of pixels along one axis of the micro-image. The variable FoV represents a field of view 510 of the micro-lens. The angular resolution Ar is defined by the number of pixels along one axis (Directional Resolution) Dr 518 divided by the projection field of view FoV. The angular resolution Ar determines a rate at which resolvable detail degrades with increased projection distance. The Angular Pitch Ap 512 is the reciprocal of the angular resolution Ar ratio and represents the point spread function of an optic system, according to the following equation:

$$Ap = \frac{FoV}{Dr} \qquad ( Equation 2 )$$

In general, the lossless projection depth may be the total depth of the prism formed by the summation of the critical heights 508 within the light-field display projection frustum, including above and below the display plane. Within the lossless projection depth, the content may be theoretically as well-defined as at the light-field display plane. Beyond this volume, the three-dimensional image may become increasingly blurry as a function of angular resolution and optical distortion. The critical height Ch 508 may be determined according to the following equation:

$$Ch = \frac{hp}{tan ( \frac{Ap}{2} )} * 0.5 \qquad ( Equation 3 )$$

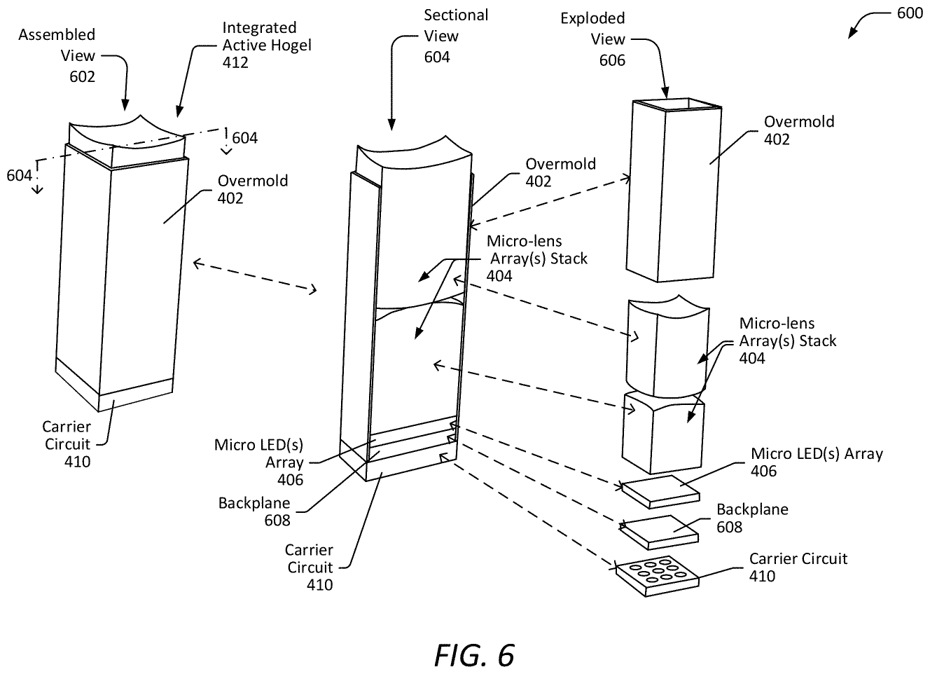

FIG. 6 depicts an implementation 600 of an integrated active hogel 412, in accordance with certain embodiments of the present disclosure. In the assembled view 602, the integrated active hogel 412 may include an overmold 402, which may secure the components of the integrated active hogel 412. The overmold 402 may function primarily to provide optical shielding to prevent stray light from one integrated active hogel 412 to interfere with an adjacent integrated active hogel 412. At a top portion of the integrated active hogel 412, a portion of the micro-lens array stack 404 is visible above the overmold 402. Below the overmold 402, a portion of the carrier circuit 410 is visible.

In the sectional view 604, which is taken along line 604-604 in the assembled view 602, the overmold 402 is shown extending around the micro-lens array stack 404. The micro-lens array stack 404 may include two micro-lens array(s) having aspherical surfaces. Other implementations are also possible. The overmold 402 may also extend around a micro-LEDs array 406 and a backplane 608, which may be coupled to the carrier circuit 410. In this example, the micro-LEDs array 406, the backplane 808, and optionally the carrier circuit 410 may be implemented as part of or may be coupled via the QFN package 408 in FIG. 4.

In the exploded view 606, the overmold 402 is a rectangular-shaped sleeve that is open on both ends. The micro-LEDs array 406, the backplane 608, and the carrier circuit 410 are depicted as substantially square, thin, planar components. In some implementations, the carrier circuit 410, the micro-LED array 406, and the backplane 608 may be coupled by or integrated with the QFN package 408 in FIG. 4.

While the integrated active hogel 412 is depicted as including the micro-lens array stack 404 including two micro-lens arrays stacked end-to end, other implementations are also possible. In an example, the micro-lens array may be implemented as an integrated structure to provide selected light rays. Other implementations are also possible.

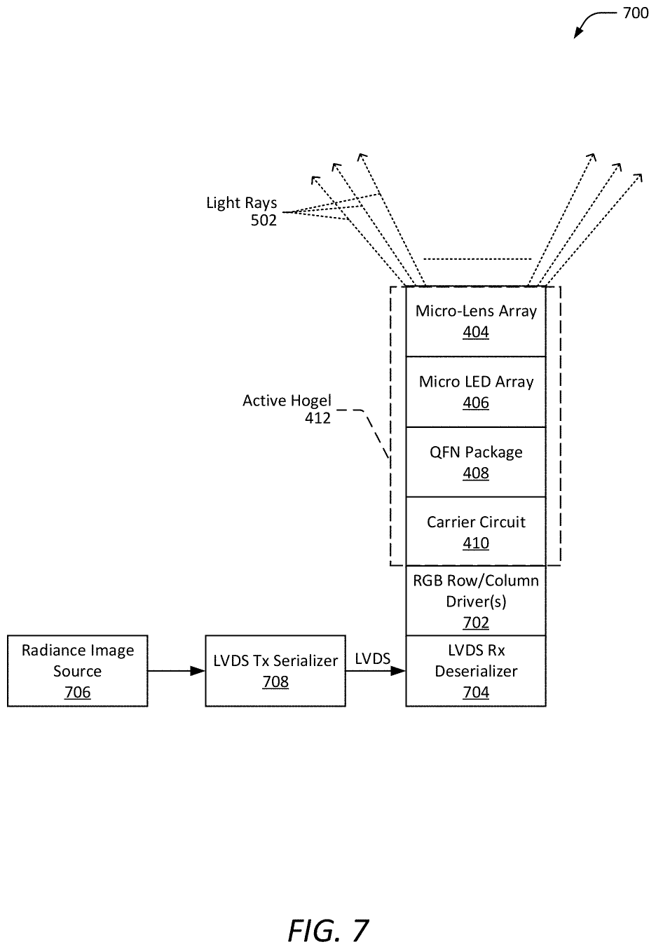

FIG. 7 depicts a block diagram of a portion of a system 700 including an integrated active hogel 412, in accordance with certain embodiments of the present disclosure. In this example, a radiance image source 706 may provide image data to a low voltage differential signaling (LVDS) serializer 708, which provides a low-voltage differential signal to an LVDS receiver de-serializer 704. The LVDS receiver de-serializer 704 provides the image data to one or more red-green-blue (RGB) row/column drivers 702, which provide pixel driver signals through the carrier circuit 410 and the quad-flat no leads (QFN) package 408 to the micro-LED array 406. The micro-LED array 406 emits light that is angularly distributed by the micro-lens array into a plurality of light rays 502.

LVDS is a general-purpose technical standard that defines the physical specification and electrical characteristics of a differential, serial communication protocol, which may operate at low-power and very high speeds using inexpensive twisted-pair wires. As compared to other types of circuit communications (particularly in a multiple-integrated circuit implementation) which may introduce common-mode noise that can impact intra-circuit communications, LVDS may be less susceptible to common-mode noise as the receivers only respond to differential voltages and generate low electromagnetic interference. In addition, LVDS is not dependent on a specific power supply and may maintain signaling performance at low voltages. Point-to-point is the simplest LVDS configuration and implies there is a single source at one end and a termination receiver on the other. Since each integrated active hogel 412 may have a single LVDS lane on which the pixel/ray signal may be driven by a field programmable gate array (FPGA) driver of the tile 414. For example, the driver FPGA may include the LVDS Tx serializer 908 to provide the LVDS signal to the integrated active hogel 412, which includes a carrier circuit 410. The carrier circuit 410 may include or may operate as the LVDS receiver de-serializer 704, which may deserialize the pixel/ray data in advance of the timing controller and the RGB row/column drivers 702.

The LVDS data rate of the LVDS receiver de-serializer 704 may be determined according to the following equations:

Pixel Clock=Rx*Ry*Fr*BPF (Equation 6)

Data Rate=Pixel Clock*Bpp (Equation 7)

where Rx and Ry represent the resolution of the μLED device, the variable Fr represents the update frame rate, the variable BPF represents the blanking period factor, and the variable Bpp represents the pits per pixel.

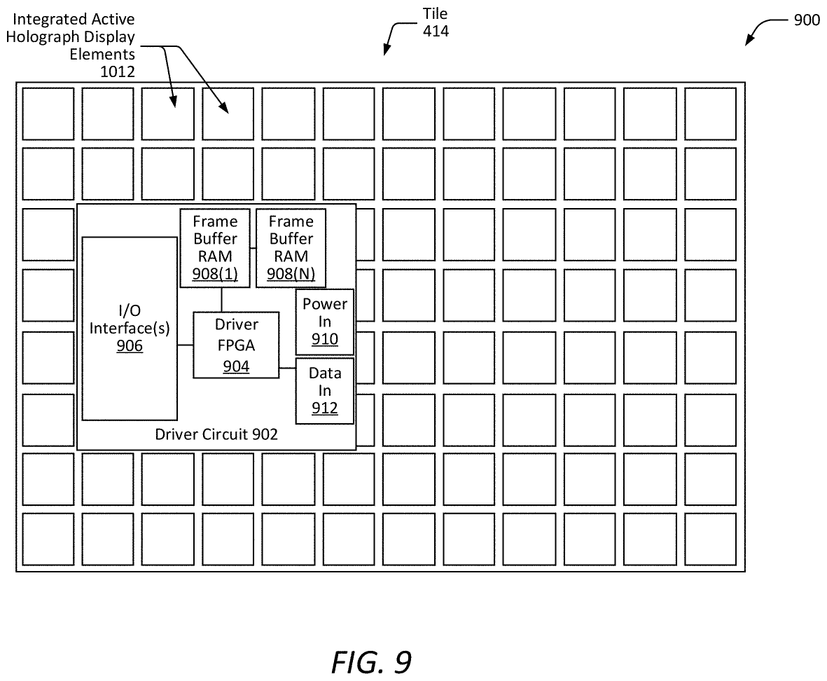

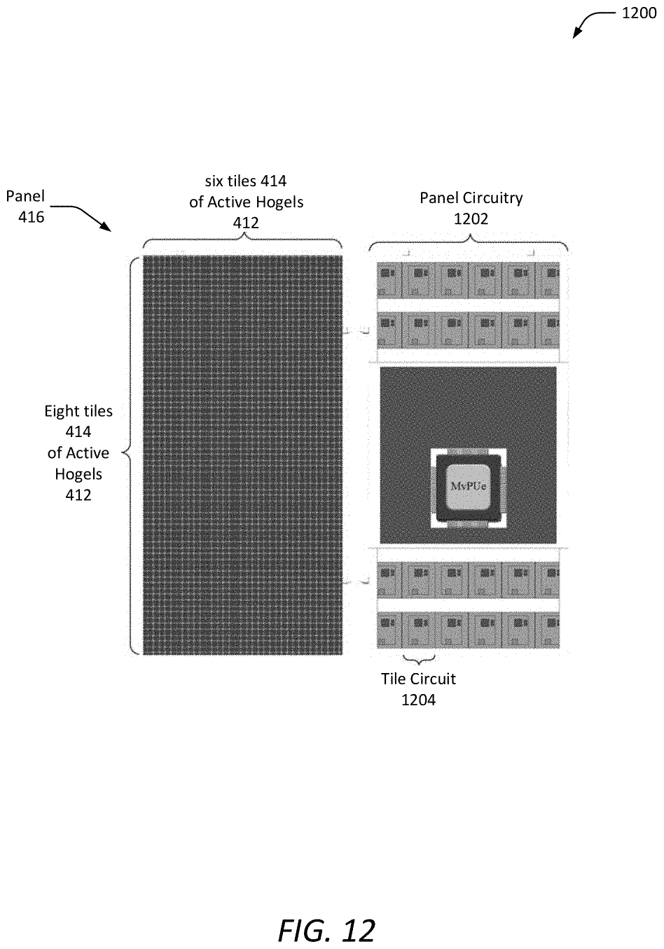

Assuming a 1:1 blanking factor (10% of row width), a monochrome 640×640 pixel μLED device may require a minimum data rate of 216 Mbps. A color 640×640 pixel μLED device may require 648 Mbps. A simple, high level functional diagram for the Active hogel de-serializer is given in FIGS. 9 and 12.

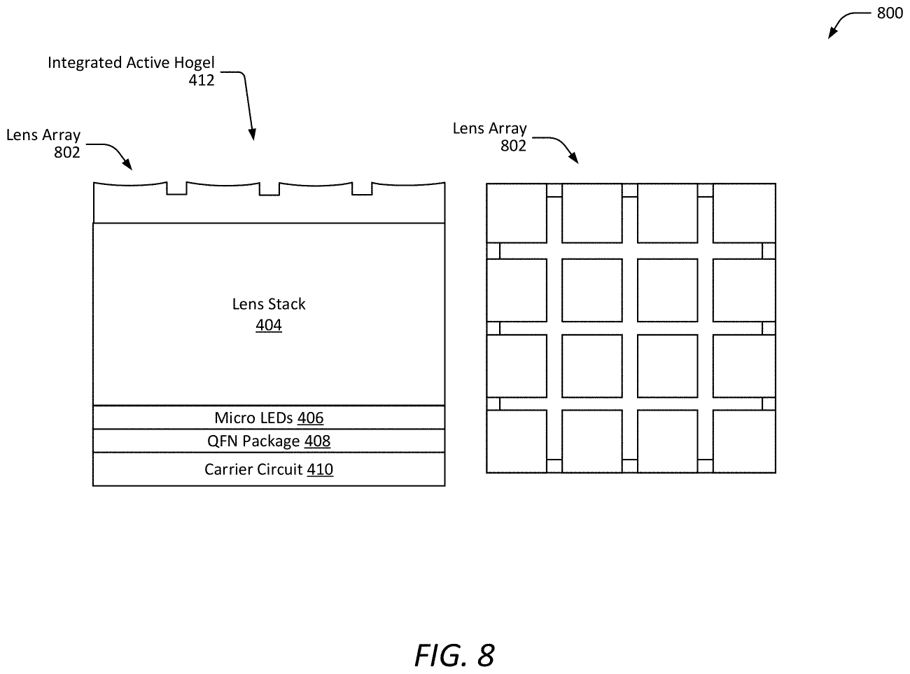

FIG. 8 depicts a block diagram 800 of an implementation of an integrated active hogels 412, in accordance with certain embodiments of the present disclosure. In this example, the integrated active hogel 412 may include a lens array 802 that is part of a lens stack 404. The integrated active hogel 412 may also include the lens stack 404 coupled to the micro-LEDs 406. The micro-LEDs 406 may be coupled to the QFN package 408, which may be coupled to the carrier circuit 410. The QFN package 408 makes it possible to pack the integrated active hogels 412 close together on the carrier circuit 410.

In this example, the lens array 802 is depicted as a 4×4 array of square lenses. Other implementations are also possible.

FIG. 9 depicts diagram 900 of a tile 414 formed from a plurality of integrated active hogels 412, in accordance with certain embodiments of the present disclosure. The tile 414 may include a driver circuit 902 including a driver field programmable gate array (FPGA) 904 coupled to one or more input/output (I/O) interfaces 906, which may be coupled to each of a plurality of integrated active hogels 412. The I/O interfaces 906 may be configured to communicate with the integrated active hogels 412 using LVDS as previously described. In some implementations, the I/O interfaces 906 may also be configured to receive instructions from another circuit, such as a panel-level circuit or a device control circuit.

The driver circuit 902 may further include memory elements, such as frame buffer random access memory (RAM) 908. The memory elements may include any number N of RAM 908, cache memories, solid-state memories, other memory devices, or any combination thereof. The driver FPGA 904 may be coupled to the memory elements, such as the RAM 908.

The driver circuit 902 may also include a power input 910 coupled to the driver FPGA 904 and to other components of the driver circuit 902. Further, the driver circuit 902 may include a data input 912 coupled to the driver FPGA 904. The data input 912 may be configured to receive video data from another circuit. For example, a panel driver circuit may send image data to the tile driver circuit 902, which image data may be received by the driver FPGA 904 via the data input 912. The driver FPGA 904 may process the receive data portion to determine portions for each of the plurality of integrated active hogels 412.

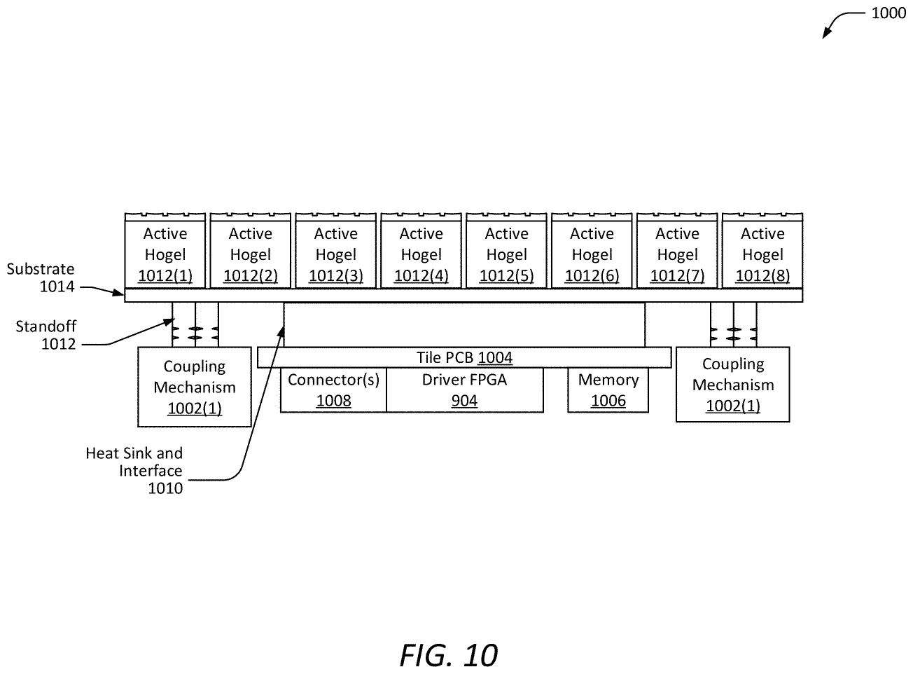

FIG. 10 depicts a portion of a display system 1000 including a plurality of integrated active hogels 412, in accordance with certain embodiments of the present disclosure. In this example, the plurality of integrated active hogels 412 are coupled to a substrate 1014. The substrate 1014 may be coupled to a printed circuit board (PCB) 1004 of a tile 414 by a heat sink and interface 1010. The heat sink and interface 1010 may be configured to dissipate heat from the driver FPGA 904 and optionally from the integrated active hogels 412.

The PCB 1004 may be coupled to the driver FPGA 904. Further, the PCB 1004 may include a memory 1006 to store data and to store instructions that may be executed by a microcontroller unit (MCU) or processor. The PCB 1004 may also include one or more connectors 1008 configured to couple to adjacent tiles 414 or to another circuit, such as a panel driver circuit, another PCB 1004, other circuits, or any combination thereof.

The system 1000 may include one or more coupling mechanisms 1002, which may be coupled to the substrate 1014 by corresponding one or more standoffs 1012. In some implementations, the coupling mechanisms 1002 may be magnetic. In other implementations, the coupling mechanisms may include bonding pads or other attachment features.

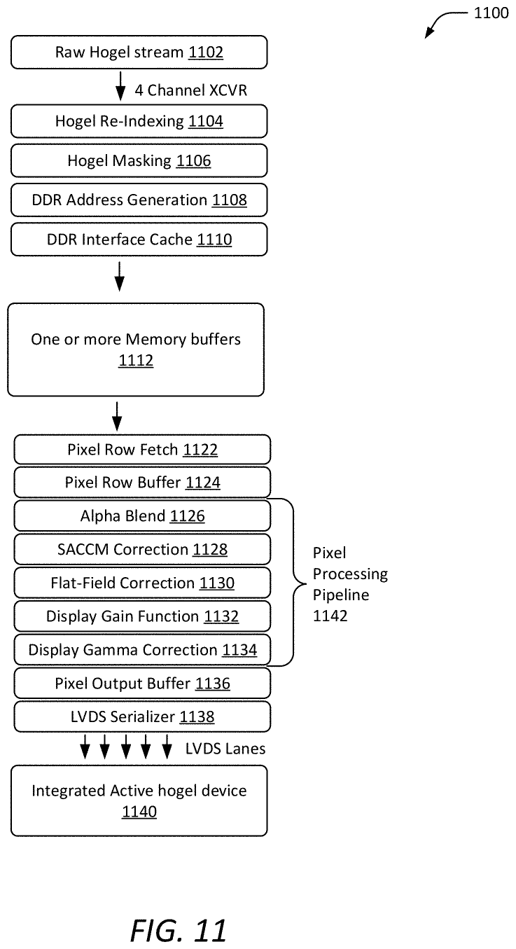

FIG. 11 depicts a diagram of a processing pipeline 1100 of a tile 414 including a plurality of integrated active hogels 412, in accordance with certain embodiments of the present disclosure. At 1102, a raw hogel data stream (i.e., image data for one or more integrated active hogels 412) is received. The raw hogel data stream may include image data that can be presented by one or more integrated active hogels 412. The tile 414 may receive indexed but uncalibrated hogel data from a radiance image generator, which may be routed via a plurality of general-purpose transceiver channels (i.e., a four-channel transceiver (XCVR)). In an example, these four XCVR channels represent an input/output (I/O) bus for the tile 414.

Upon receipt of the data, the first stage of the processing pipeline includes re-indexing the hogel data, at 1104, to determine a memory location of the integrated active hogels 412 based on the layer and the image data index. At 1106, hogel masking is applied to blank out non-active pixels. At 1108, an address is generated for the double data rate (DDR) memory and, at 1110, the raw hogel data is stored in the DDR interface cache.

The data is written to one or more memory buffers in the second stage. The memory buffers 1112 may include layer 1 frame buffers, layer 2 frame buffers, double-data rate (DDR) memory buffers, and so on. In some implementations, in conjunction with storage in the memory buffers, the processor pipeline may determine a spatially addressable color correction matrix (SACCM), flat-field or uniformity corrections, display gain, display gamma correction, and other corrections to the raw hogel data. The processing pipeline may also serialize the hogel data and embed clock and control signs to drive a micro-LED device.

In the next stage, the processing pipeline may fetch pixel rows 1122 and store the data in a pixel row buffer 1124. In the pixel-processing pipeline 1142, the pipeline performs the alpha blend 1126, the SACCM correction 1128, the flat-field correction 1330, the display gain function 1132, and the display gamma correction 1134. The resulting display data may be provided to a pixel output buffer 1136 and to the low-voltage differential signaling (LVDS) serializer 1138, which may provide the data to the integrated active hogel device 1140.

FIG. 12 depicts a diagram 1200 of a panel 416 formed from a plurality of tiles 414 and corresponding panel circuitry 1202, in accordance with certain embodiments of the present disclosure. The panel circuitry 1202 may include a multi-view processing unit (MvPUe) or a graphics processing unit (GPU) and a plurality of tile circuits 1204. The tile circuit 1204 may include hogel driver circuitry and other circuitry to drive the display tiles 414 comprised of a plurality of integrated active hogels 412. Other implementations are also possible.

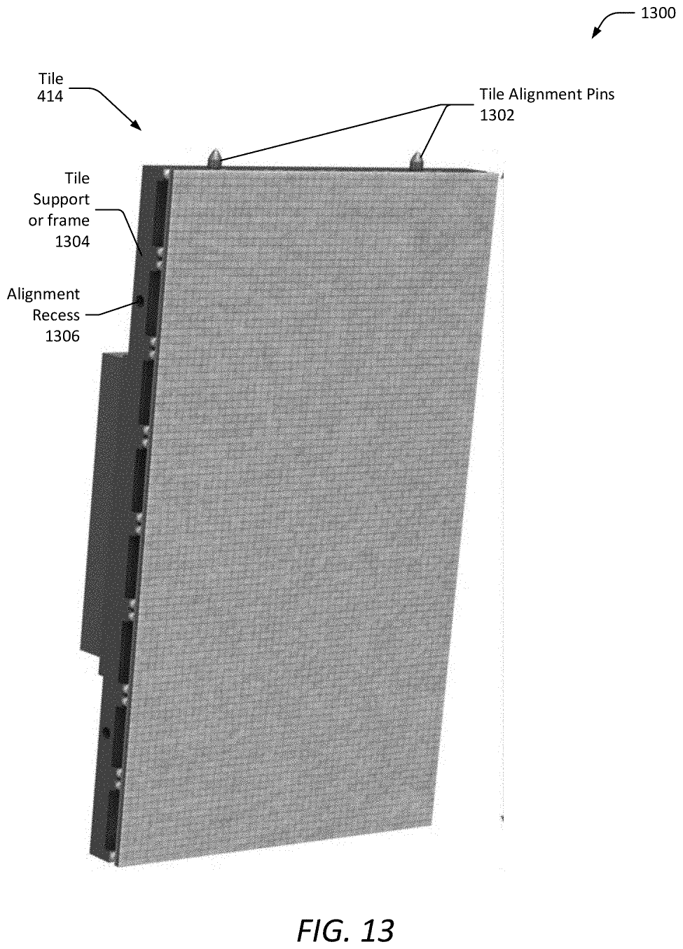

FIG. 13 depicts a diagram 1300 of a tile 414 including tile alignment pins 1302 to enable alignment of the tile 414 relative to adjacent tiles to form a panel, in accordance with certain embodiments of the present disclosure. The tile 414 may include a plurality of integrated active hogels 412. The alignment pins 1302 may align with recesses 1306 or openings on adjacent tiles 414 to form a panel 416. The tile alignment pins 1302 may be part of a tile support or frame 1304 and may align to one or more alignment recesses 1306 to enable correct and tight alignment of adjacent tiles 414.

The tile alignment pins 1302 may be present along an edge of the tile support or frame 1304 opposite to the alignment recess 1306. Further, alignment recesses 1306 may be present along an edge of the tile support or frame 1304 that is opposite to the edge that has the tile alignment pins 1302. The alignment recesses 1306 may receive the tile alignment pins 1302 to mechanically align and secure a first tile 414 to one or more adjacent tiles 414.

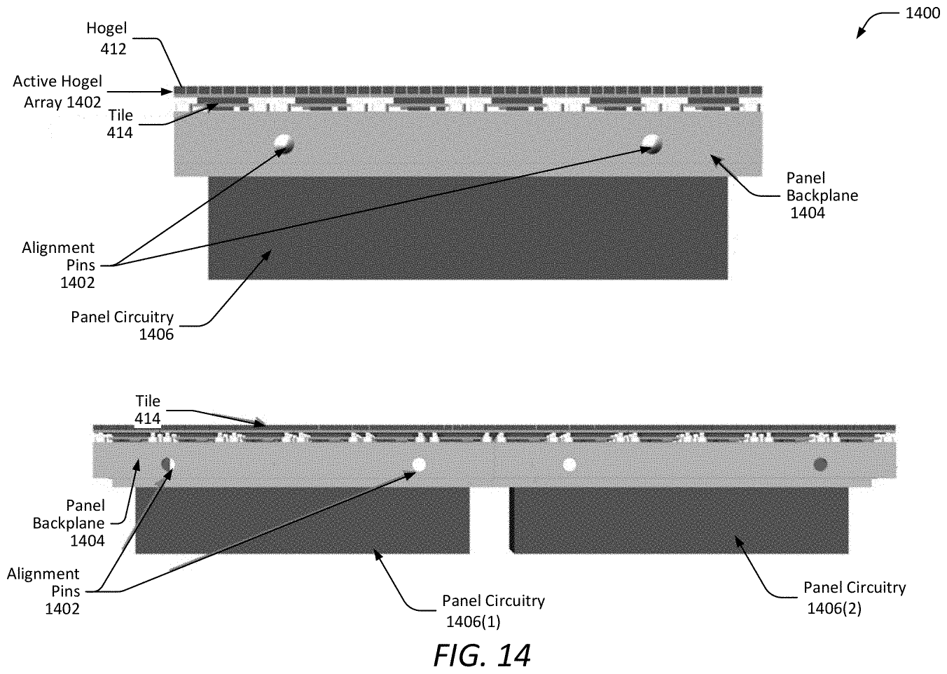

FIG. 14 depicts a diagram 1400 of a display element formed of tiles 414 including integrated active hogels 412, in accordance with certain embodiments of the present disclosure. In this example, an active hogel array 1402 is formed of a plurality of tiles 414 comprised of integrated active hogels 412. The tiles 414 may be coupled to one another and to panel circuitry 1406 via a panel backplane 1404.

As shown, the tiles 414 may be coupled together to form the panel 416. Panel circuitry 1406(1) may drive circuitry of a first tile 414(1), while panel circuitry 1406(2) may drive circuitry of a second tile 414(2). Other implementations are also possible.

In some implementations, a display device may be comprised of multiple panels 416, where each panel 416 is comprised of multiple tiles 414. Each tile 414 may be comprised of a plurality of integrated active hogels 412. In the illustrated example, a first panel 416(1) may include panel circuitry 1406(1), and a second panel 416(2) may include panel circuitry 1406(2). The panel circuitry 1406 may communicate data to tile circuitry of the tile 414, which may communicate data to each integrated active hogel 412. Additionally, the panel circuitry 1406 may communicate with a device circuit, such as, for example, the touch control interface 106 discussed with respect to FIG. 1.

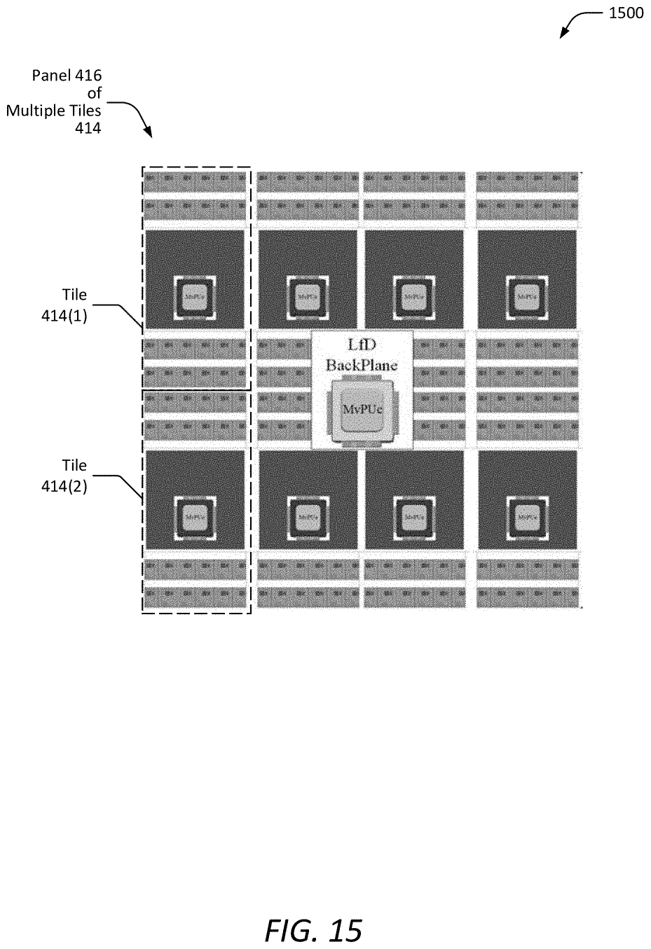

FIG. 15 depicts a display apparatus 1500 comprised of a panel 416 formed of multiple tiles 414, which are comprised of integrated active hogels 412, in accordance with certain embodiments of the present disclosure. In this example, the apparatus 1500 may include a plurality of tiles 414 joined together and aligned according to the tile alignment pins 1306 to form a display panel apparatus 1500.

In the illustrated example, each tile 414 may be formed of a plurality of integrated active hogels 412. Each integrated active hogel 412 may include circuitry that communicates via LVDS protocols with a tile-level circuit that may include a multi-view processing unit (MvPU) or a graphics processing unit. Further, each tile-level circuit may communicate with a light-field driver backplane and associated MvPU or GPU of the panel circuitry. The panel circuitry of each panel may communicate with a circuit associated with the display device.

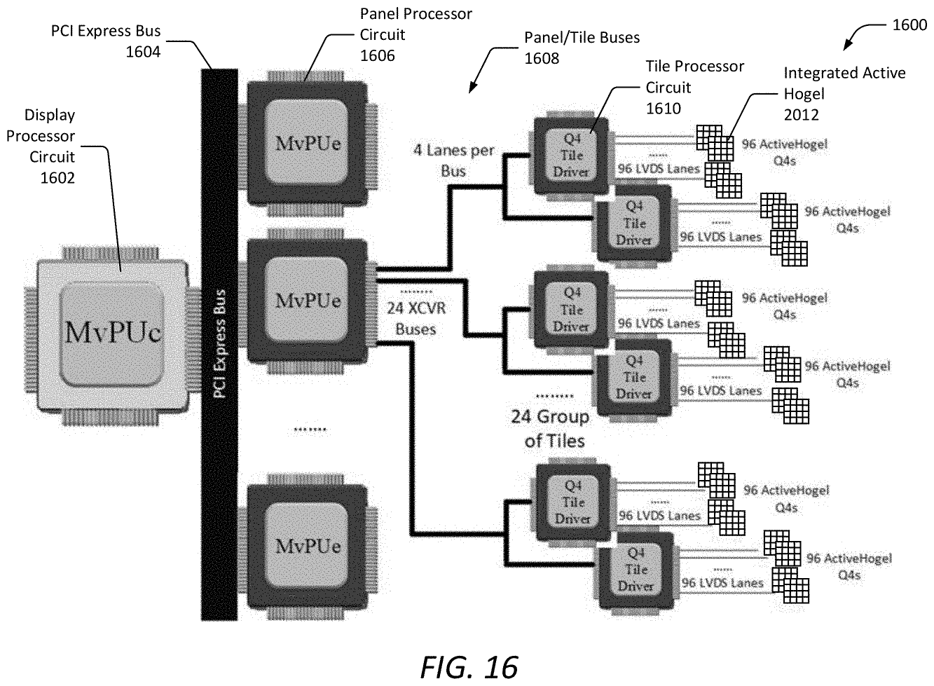

FIG. 16 depicts a block diagram of a bus architecture 1600 of an embodiment of a display system including one or more panels 416 comprised of a plurality of tiles 414 comprised of a plurality of sets of active hogels 412, in accordance with certain embodiments of the present disclosure. In this example, the circuitry is arranged hierarchically to provide the display device. The circuitry includes, at a first level, a display processor circuit 1602, which is coupled to a peripheral component interconnect (PCI) express bus 1604. At a next level, multiple panel processor circuit 1606 are coupled to the PCI express bus 1604. Each panel processor circuit 1606 may be coupled via transceiver (XCVR) panel/tile buses 1608 to multiple tile processor circuit 1610. Each of the tile processor circuit 1610 may be coupled to an array 1612 of integrated active hogels 412.

In the illustrated example, 24 panel/tile buses 1608 couple each of the panel processor circuits 1606 to 24 tile processor circuits 1610. Each of the tile processor circuits 1610 may be coupled to multiple integrated active hogels 412. Each array 1612 may be coupled to an associated tile processor circuit 1610 by 96 low-voltage differential signaling lanes, such that each array includes 96 integrated active hogels 412.

The display processor circuit 1602, the panel processor circuit 1606, and the tile processor circuit 1610 may include more than 96 LVDS lanes, allowing for inter-circuit communication as well as headroom for failover. In some implementations, one of the tile processor circuits 1610 may be coupled to one or more other tile processor circuit 1610. Similarly, a first panel processor circuit 1606 may be coupled to a second panel processor circuit 1606. Other implementations are also possible.

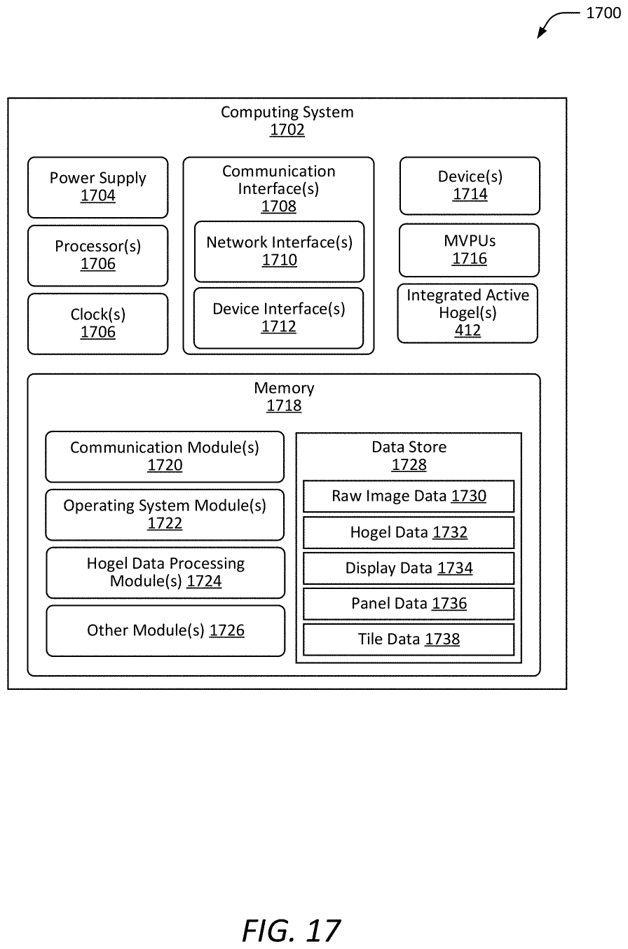

FIG. 17 depicts a block diagram of a system 1700 including integrated active hogels 412, in accordance with certain embodiments of the present disclosure. In this example, the system 1700 includes a computing system 1702, such as a laptop computer, a tablet computer, a smartphone, another computing device, or any combination thereof. In some implementations, the computing system 1702 may be integrated within a display device, such as in the control electronics behind a plurality of panels that are electrically and mechanically coupled.

The computing system 1702 may include a power supply 1704, such as a battery or another type of power supply, such as a power management circuit coupled to a wall socket. The computing system 1702 may include one or more processors 1706 configured to process data and to execute processor readable instructions. The computing system 1702 may also include one or more clocks 1706, which may provide ticks or clock signals for signal transmission/reception and for operating the processors 1706. In some implementations, the ticks or clock signals may be used to process video frames.

The computing system 1702 may include one or more communication interfaces 1708. The communication interfaces 1708 may include one or more network interfaces 1710, which may be configured to communicate with a local area network (LAN), a wide area network (WAN) (such as the Internet), short-range wireless networks (such as a Bluetooth® communications link), other networks or other communications links, or any combination thereof.

The communication interfaces 1708 may also include one or more device interfaces 1712. The device interfaces 1712 may include universal serial bus (USB) interfaces, serial interfaces, other interfaces, or any combination thereof. The device interfaces 1712 may be configured to communicate with one or more devices 1714. The devices 1714 may include input devices, such as keyboards, pointer devices, scanners, microphones, cameras, other input devices, or any combination thereof. The devices 1714 may also include one or more output devices, such as displays, speakers, printers, haptic devices, other devices, or any combination thereof. The device interfaces 1712 may also be configured to communicate data to one or more processing units 1716 and to one or more integrated active hogels 412, directly or through one or more intermediary circuits, such as a panel control circuit, a tile control circuit, a carrier circuit, and so on. In some implementations, the integrated active hogels 412 may be part of the computing system 1702. In other implementations, the integrated active hogels 412 may be output devices that are external to the computing system 1702.

The computing system 1702 may also include one or more memory devices 1718. The memory devices 1718 may include a solid-state memory, cache memory, random access memory (RAM), other memory devices, or any combination thereof.

The compute 1718 may include one or more hogel data processing modules 1724. In some implementations, the hogel data processing modules 1724 may cause the processor to receive raw hogel data and to process the raw hogel data, and apply corrections, display gain functions, and other data. The resulting processed hogel data may be provided to the device interface 1712 and to the integrated active hogels 412. Other implementations are also possible.

The memory 1718 may include a data store 1728, which may store raw image data 1730, hogel data 1732, display data 1734, panel data 1736, tile data 1738, and the like. The computing system 1702 may communicate data from the data store 1728 (or from the one or more processors 1706) to one or more of a panel 416, a tile 414, and an integrated active hogel 12. Other implementations are also possible.

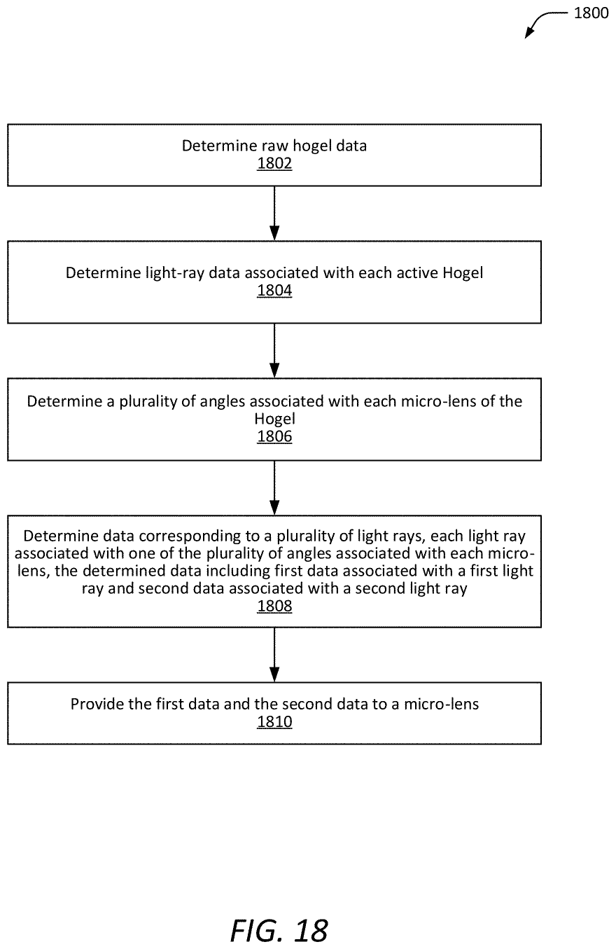

FIG. 18 depicts a flow diagram of a method 1800 of providing a light-field holographic display using integrated active hogels 412, in accordance with certain embodiments of the present disclosure. At 1802, the method 1800 may include determining raw hogel data. In some implementations, the raw hogel data may be determined by retrieving the raw image data 1730 from the memory 1718. In other implementations, the raw hogel data may be determined by receiving the hogel data from a source, such as another computing device or a content provider.

At 1804, the method 1800 may include determining light-ray data associated with each integrated active holographic display element. The determination of the light-ray data may include re-indexing of the hogel, hogel masking, DDR address generation, data correction, determination of gain functions, and so on. The light-ray data may also include other data.

At 1806, the method 1800 may include determining a plurality of angles associated with each micro-lens of the integrated active holographic display element 1806. The number of angles may be determined, in part, based on the field of view of the micro-lens.

At 1808, the method 1800 may include determining data corresponding to a plurality of light rays, where each light ray is associated with one of the plurality of angles associated with each micro-lens, the determined data including first data associated with a first light ray and second data associated with a second light ray. For example, the processor may determine a light ray for each angle of the micro-lens. The first light ray and the second light ray may have different intensities and other differences in visual properties.

At 1810, the method 1800 may include providing the first data and the second data to a micro-lens. In an example, the first data, the second data, and other data may be provided to a carrier circuit of an integrated active holographic display element 1012, which may drive one or more light-emitting elements to provide the plurality of rays to the micro-lens array. Other implementations are also possible.

In conjunction with the systems, methods, and devices described above with respect to FIGS. 1-18, an integrated active hogel may include a QFN package including an array of light-emitting elements and may include one or more micro-lenses to angularly distribute the emitted light into a plurality of light rays of different intensities. Each light ray may represent a hogel data from a selected angle of a plurality of angles. The light rays may be of different intensity, depending on the angle, allowing for three-dimensional views from various angles within the field of view. Other implementations are also possible.

In some implementations, a display device may be comprised of a plurality of integrated active hogels organized into arrays, which may be interconnected to form tiles. The tiles may be interconnected to form panels, which may be interconnected to form displays. Panel level circuitry may control the display at the panel level, while tile level circuitry may control the display at the tile level. Each integrated active hogel may include an integrated circuit to control micro-LEDs to emit light, and the micro-lenses to angularly distribute the emitted light. Other implementations are also possible.

In some implementations, a display device may be comprised of circuitry including small spatial light modulators (SLM) including a small, high-density, pixel array coupled to a micro-lens array to provide a three-dimensional holographic image. The SLM for the integrated active holographic display element may have all the pixels and the drive logic to project from a single hogel. This small integrated SLM may reduce the issue of yield loss for large, high-pixel-density SLMs and may simplify the lenslet array fabrication. In an implementation, each integrated active hogel may be comprised of a complete SLM coupled to a micro-lens optic forming a building block of a light-field display. This self-contained integrated active hogel may be arrayed with other integrated active hogels on a suitable backplane such as a printed circuit board, which may route power and hogel data to the individual hogels, allowing for the creation of a light-field display that may be scaled to provide a selected size. In some implementations, depending on placement tolerance during array assembly, quality and fidelity of the integrated active hogel array may be improved by performing post-assembly calibration using machine vision algorithms to measure the relationship of each individual integrated active hogel relative to a whole display plenoptic function and by adjusting one or more parameters associated with each integrated active hogel to provide improved light-field distribution.

Alternatively, small groups of integrated active hogels may be manufactured for tiling in the same manner. For example, instead of manufacturing the assembly to be a single integrated active hogel, a group of N×M integrated active hogels could be manufactured, e.g., in a 2×2 configuration, a 3×4 configuration, a 4×4 configuration, a 5×10 configuration, a 10×10 configuration, and so on. If the I/O interface limits the size to one that is smaller than the desired light-field display, then the array of integrated active hogels can be used as a sub-panel, which could itself be tiled to make a larger display. Each integrated active hogel may be light-shielded from adjacent hogels by an overmold, which may encapsulate the circuit components as well as the light-emitting array and a portion of the micro-lens to prevent light leakage between the lens arrays. Other implementations are also possible.

Although the present invention has been described with reference to preferred embodiments, workers skilled in the art will recognize that changes may be made in form and detail without departing from the scope of the invention.

What is claimed is:

1. An apparatus comprising:
a display circuit; and
a plurality of integrated holographic elements (hogels) coupled to the display circuit, each hogel of the plurality of integrated active hogels comprising:
one or more light-emitting elements; and
a micro-lens array to angularly distribute light from the one or more light-emitting elements; and
drive circuitry coupled to the one or more light-emitting elements, the drive circuitry implemented in a quad flat no leads (QFN) package.

2. The apparatus of claim 1, wherein the drive circuitry receives data from a second circuit using low-voltage differential signaling.

3. The apparatus of claim 1, wherein each hogel of the plurality of integrated active hogels comprises an overmold to encapsulate the one or more light-emitting elements and at least a portion of the micro-lens to prevent light leakage to others of the plurality of integrated active hogels.

4. The apparatus of claim 1, further comprising:
a plurality of tiles, each tile of the plurality of tiles including:
a subset of the plurality of integrated active hogels;
tile circuitry to provide first data to the subset; and
a support including one or more alignment pins to engage adjacent tiles to facilitate alignment of the tiles into an array of tiles.

5. The apparatus of claim 4, further comprising:
a plurality of panels, each panel of the plurality of panels including:
a second subset of the plurality of tiles; and
panel circuitry to provide second data to the tile circuitry of each of the tiles of the array of tiles.

6. The apparatus of claim 5, further comprising:
a display comprising the plurality of panels; and
wherein the display circuit is coupled to the panel circuitry and configured to provide display data to the panel circuitry of each panel of the plurality of panels independent of other panels of the plurality of panels, the display circuit to coordinate presentation of the display data across the plurality of panels; and
wherein the panel circuitry determines a plurality of portions of the display data, the panel circuitry to provide a selected portion of the plurality of portions to a selected one of the plurality of panels.

7. An apparatus comprising:
a plurality of integrated active holographic elements (hogels), each integrated active hogel comprising:
one or more light-emitting elements;
one or more micro-lenses; and
optical driver circuitry coupled to the one or more light-emitting elements, the optical driver circuitry integrated into a quad flat no leads (QFN) package.

8. The apparatus of claim 7, wherein the plurality of integrated active hogels are arrayed to form a light field display.

9. The apparatus of claim 7, wherein each integrated active hogel comprises an overmold formed from an opaque material, the overmold to extend around the one or more light-emitting elements to reduce light leakage between adjacent integrated active hogels of an array of integrated active hogels.

10. The apparatus of claim 7, wherein the micro-lens extends over the one or more light-emitting elements to angularly distribute light into a plurality of light rays.

11. The apparatus of claim 7, further comprising a plurality of tiles, each tile of the plurality of tiles including:
a subset of the plurality of integrated active hogels;
tile circuitry to provide first data to the subset; and
a support including one or more alignment pins to engage adjacent tiles to facilitate alignment of the tiles into an array.

12. The apparatus of claim 11, further comprising a plurality of panels, each panel of the plurality of panels including:
a second subset of the plurality of tiles; and
panel circuitry to provide second data to the tile circuitry.

13. The apparatus of claim 12, further comprising:
a display comprising the plurality of panels; and
wherein the display circuit is coupled to the panel circuitry and configured to provide display data to the panel circuitry of each panel of the plurality of panels independent of other panels of the plurality of panels; and
wherein the panel circuitry determines a plurality of portions of the display data, the panel circuitry to provide a selected portion of the plurality of portions to a selected one of the plurality of tiles.

14. An apparatus comprising:
a plurality of integrated active holographic elements (hogels), each hogel comprising:
one or more light-emitting elements;
a micro-lens to angularly distribute light from the one or more light-emitting elements; and
circuitry to drive the one or more light-emitting element, the circuitry implemented as a quad flat no leads (QFN) package.

15. The apparatus of claim 14, where each integrated active hogel of the plurality of integrated active hogels further comprises an overmold extending around a periphery of the one or more light-emitting elements to reduce light leakage between adjacent ones of the plurality of integrated active hogels.

16. The apparatus of claim 14, wherein the plurality of integrated hogels forms an array to present a light-field three-dimensional image using a light-field display.

17. The apparatus of claim 14, further comprising a plurality of tiles, each tile of the plurality of tiles including:
a subset of the plurality of integrated hogels;
tile circuitry to provide first data to the subset; and
a support including one or more alignment pins to engage adjacent tiles to facilitate alignment of the tiles into an array to form a panel.

18. The apparatus of claim 17, further comprising a plurality of panels, each panel of the plurality of panels including:
a second subset of the plurality of tiles; and
panel circuitry to provide second data to the tile circuitry.

19. The apparatus of claim 18, further comprising a display comprising the plurality of panels, wherein:
the display circuit is coupled to the panel circuitry and configured to provide display data to the panel circuitry of each panel of the plurality of panels independent of other panels of the plurality of panels; and
the panel circuitry determines a plurality of portions of the display data, the panel circuitry to provide a selected portion of the plurality of portions to a selected one of the plurality of tiles.

20. The apparatus of claim 14, wherein the micro-lens extends over the one or more light-emitting elements to angularly distribute light into a plurality of light rays.
